(19) United States
(12) Patent Application Publication
(10) Pub. No.: US 2014/0181203 A1
(43) Pub. Date: Jun. 26, 2014

(54) METHODS AND ARRANGEMENT FOR DISPATCHING REQUESTS

(71) Applicants: Cormac Hegarty, Bromma (SE); David Castellanos Zamora, Stockholm (SE); Juan Manuel Fernandez Galmes, Getafe (Madrid) (ES)

(72) Inventors: Cormac Hegarty, Bromma (SE); David Castellanos Zamora, Stockholm (SE); Juan Manuel Fernandez Galmes, Getafe (Madrid) (ES)

(73) Assignee: Telefonaktiebolaget L M Ericsson (publ), Stockholm (SE)

(21) Appl. No.: 14/124,098

(22) PCT Filed: Jun. 15, 2011
(86) PCT No.: PCT/SE2011/050743

§ 371 Date: Feb. 11, 2014

(51) Int. Cl. H04L 29/08

(52) U.S. Cl. CPC H04L 67/32
USPC 709/204

(57) ABSTRACT

Methods and apparatuses for performing domain resolution prior to dispatching a request. A request from an Application Server (AS) is received. The AS and a network node are present in a first network domain. At least one target network domain is determined based on at least one domain indicator in the request. The domain indicator being associated with at least a part of the request, wherein the target network domain is one of: the first network domain and a second network domain. Then, the at least part of the request is dispatched, to at least one subscriber server present in the determined target network domain(s).

### TECHNICAL FIELD

The invention relates generally to a method and an arrangement for dispatching requests. The invention relates more specifically to dispatching requests to multiple network domains.

### BACKGROUND

In recent years, new Radio Access Technologies (RATs), network architectures and service architectures have emerged in order to enable new functionality and increased capacity in telecommunication networks. Ensuring interoperability in telecommunication networks of today is thus becoming increasingly complex. Moreover, these emerging RATs and architectures may be provided to the operators of the telecommunication networks by many different vendors. Since each RAT and/or network/service architecture may be sourced individually and/or independently from each other, more than one vendor commonly supply the network operator with network equipment, service architectures, deployment and maintenance.

The development of a multivendor environment drives the demand for new solutions for ensuring interoperability between different RATs and service architectures. This may, for example, involve topology encapsulation, i.e. hiding the involved servers with a single point of service, in order to avoid strong relationships and entity coupling which may decrease the scalability and increase the complexity of the system. Also various dispatching functions may nowadays be needed in order to reformat and translate communication from one protocol and/or format into another.

Although standardization is heavily applied in the field of telecommunication in order to achieve interoperability, the mobile operators are experiencing a need for efficient solutions for allowing information to be gathered and provided from one RAT and/or service architecture to another. Previously, this issue would be solved by the vendor, based on the operator's deployment requirements. This is, however, not a viable solution today due to the increased number of vendors and the increased complexity in terms of the number of RATs and architectures deployed in the operator's network. It has thus been recognized as a problem that dispatching requests from a first RAT and/or service architecture, provided by a first vendor, to a second RAT and/or service architecture, provided by a second vendor, introduces complexity and may require support for multiple redundant protocols.

### SUMMARY

It is an object of the invention to address at least some of the limitations, problems and issues outlined above. It is also an object to improve the process of dispatching requests to two or more network domains. It is possible to achieve these objects and others by using a method and an arrangement as defined in the attached independent claims.

According to one aspect, a method for performing domain resolution prior to dispatching a request, performed by a network node, is provided. A request is received, at the network node, from an Application Server (AS). The AS and the network node are present in a first network domain. At least one target network domain is determined based on at least one domain indicator in the request. The domain indicator is associated with at least a part of the request. The target domain is one of a first network domain and a second network domain. The at least part of the request is dispatched to a subscriber server which is present in the determined target network domain(s).

According to another aspect, a domain resolution unit adapted to perform domain resolution prior to dispatching a request, is provided. The domain resolution unit comprises a receiving unit which is adapted to receive a request from an AS. The AS and the domain resolution unit are present in a first network domain. The domain resolution unit further comprises a determining unit which is adapted to determine at least one target network domain based on at least one domain indicator in the request. The domain indicator being associated with at least a part of the request. The target domain is one of a said first network domain and a second network domain. The domain resolution unit further comprises a dispatching unit which is adapted to dispatch, at least part of the request, to at least one subscriber server which present in the determined target domain(s).

The above method and arrangement may be configured and implemented according to different embodiments. In one example embodiment, the received request comprises a first domain indicator which may be indicating the first network domain, and a second domain indicator which may be indicating the second network domain. The request may be divided into a first sub-request associated with the first domain indicator. The first sub-request may be dispatched to a subscriber server present in a first network target domain, and a second sub-request associated with said second domain indicator, wherein the second part may be dispatched to a subscriber server present in the second target network domain.

According to another possible example embodiment, one or more responses to the dispatched sub-requests are received from two or more domains and the received responses are aggregated to form a common single response, to the AS, from two or more domains.

According to another possible example embodiment, the domain indicator may be one of a data reference or a domain request.

According to another possible example embodiment, the first and second network domain may be one of IP Multimedia System (IMS), General packet radio service (GPRS) network, Evolved Packet Core (EPC) network or Circuit Switched (CS) network.

According to another possible embodiment, the domain resolution function and its related arrangement may reside in, or be co-located with, a Subscriber Location Function (SLF) and/or a Diameter Proxy Agent.

### BRIEF DESCRIPTION OF DRAWINGS

The invention will now be described in more detail by means of exemplary embodiments and with reference to the accompanying drawings, in which:

FIG. 1 is a block diagram illustrating a request from an application server, the request is dispatched to a subscriber server by a domain resolution function, according to one example embodiment.

FIG. 2 is a block diagram illustrating a request from an application server which is divided into sub-requests before it is dispatched to multiple-domains, according to one example embodiment.

FIG. 3 is a block diagram illustrating a domain resolution function which is co-located with a Subscriber Locator Function, according to one example embodiment.

FIG. 4a is a flow chart illustrating a procedure for dispatching a request into a target domain, according to one example embodiment.

FIG. 4b is a flow chart illustrating a procedure for dividing a request into sub-requests which are dispatched into multiple target domains, according to one example embodiment.

FIG. 5 is a block diagram illustrating an arrangement for dispatching a request into a target domain, according to further example embodiments.

FIG. 6 is a block diagram illustrating an arrangement in a network node, according to one example embodiment.

### DETAILED DESCRIPTION

Briefly described, a solution is provided for dispatching a request from an AS. The request may be dispatched to one or more subscriber servers. The subscriber server may reside in a network domain which is identical to the network domain in which the AS is present. However, the subscriber server may also be present in a network domain which is different from the network domain in which the AS is present. Hence, a solution is provided for dispatching requests from an AS in one network domain to a subscriber server in the same or another network domain without any modification or adoptions at the AS. Moreover, a solution is provided for enhancing the network domain interoperability.

In this description, the term “network domain” refers to a network type, such as for example a RAT in an access network, or a network and/or service architecture, such as for example IMS. Normally, each network domain is standardized and comprises certain specific interfaces and/or specific communication protocols. A non-limiting list of examples of domain-types is: IMS, GPRS networks, EPC networks or/or CS networks.

Since a request, associated with a single user, from an AS may be directed to subscriber servers in different network domains, several protocols may have to be supported. Hence, if the AS is to be responsible for providing the requests to the subscriber server, then it may be necessary to support redundant protocols. Moreover, a system where each AS maintains records for subscribers and subscriber servers present in different network domains may scale in an inefficient and sub-optimal manner.

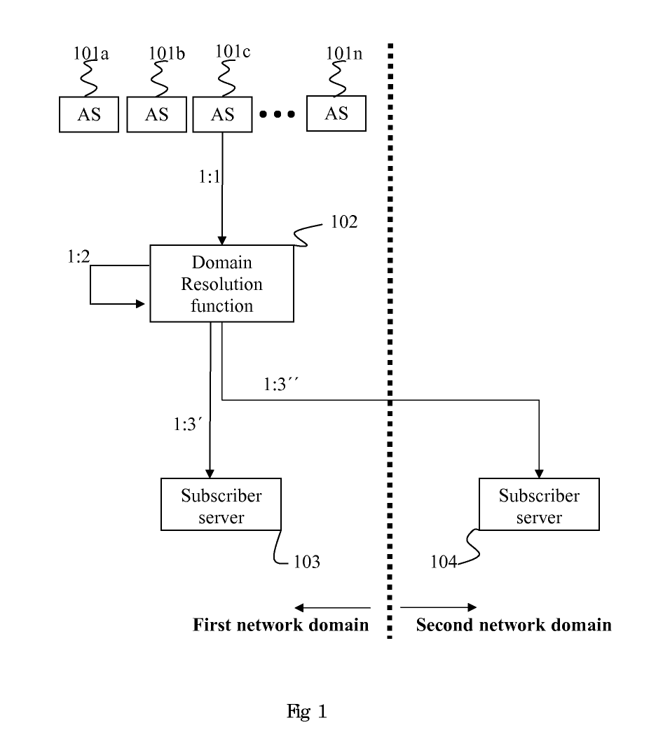

With reference to FIG. 1, a block diagram illustrating a scenario of a procedure for dispatching a request into a target network domain will now be described. In this description, the term “target network domain” shall indicate one or more network domains to which a request, a part of the request or a sub-request, is intended.

According to the example embodiment illustrated with reference to FIG. 1, a plurality of ASs 101a-n and a domain resolution function 102 are present in a first network domain. However, the domain resolution function 102 could also be present in another network domain, other than the network domain of the AS 101a-n.

In a first action 1:1, one of the AS 101c issues a request which is received by the domain resolution function 102. The domain resolution function 102 determines, in action 1:2, based on a domain indicator, at least one target network domain being one of the first network domain and a second network domain.

In this description, the term “domain domain indicator” shall mean an indicator in a request from a network node, such as for example the AS 101a-n in FIG. 1. The domain indicator indicates, implicitly or explicitly to which network domain the request is intended, i.e. a target domain. Thus, the domain indicator may be included in the header in a request and/or embedded in the content of the request. If the domain indicator is implicitly indicating the requested domain, then some additional analysis may be done in order to match the domain indicator with a target domain.

It should also be understood that a request may comprise more than one domain indicator. In that case, the domain indicators may be associated with different parts of the request, i.e. to different sub-requests therein, that should be dispatched to subscriber servers present in different network domains. A scenario of one request from the AS which is divided into plural sub-requests will be further discussed below.

In one particular example embodiment, the domain indicator may be the data reference type which is comprised in a “Sh request” in the “Sh reference point” between an AS and a Home Subscriber Server (HSS) in IMS. The “Sh reference point” is further described in 3GPP TS 29.328. However, in another embodiment, other domain indicators are also possible. A non-limiting example of such domain indicator indicating the intended network domain may be additional information in the “Sh request” such as information relating to requested domain or whether CS/PS or EPS should be used for location information.

Returning to FIG. 1, the domain resolution function 102 then dispatches the request to the target domain based on the domain indicator in the request. For the purpose of simplicity and clarity, FIG. 1 only shows two network domains. However, one domain resolution function 102 could serve and dispatch requests to any number of network domains.

If the target domain indicated by the domain indicator in FIG. 1, is the first network domain, the domain resolution function 102 dispatches the request to a subscriber server 103 present the first network domain, which is illustrated by action 1:3′. However, if the target domain is the second network domain, then the domain resolution function 102 dispatches the request to a subscriber sever 104 present in the second network domain, which is illustrated by action 1:3″.

In this description, the term “subscriber server” shall mean an entity wherein subscriber related information is stored and accessed. According to one example, the subscriber server may be a HSS. The HSS is further described in 3GPP TS 23.002 which defines a master database for subscriber-related information for a specific user.

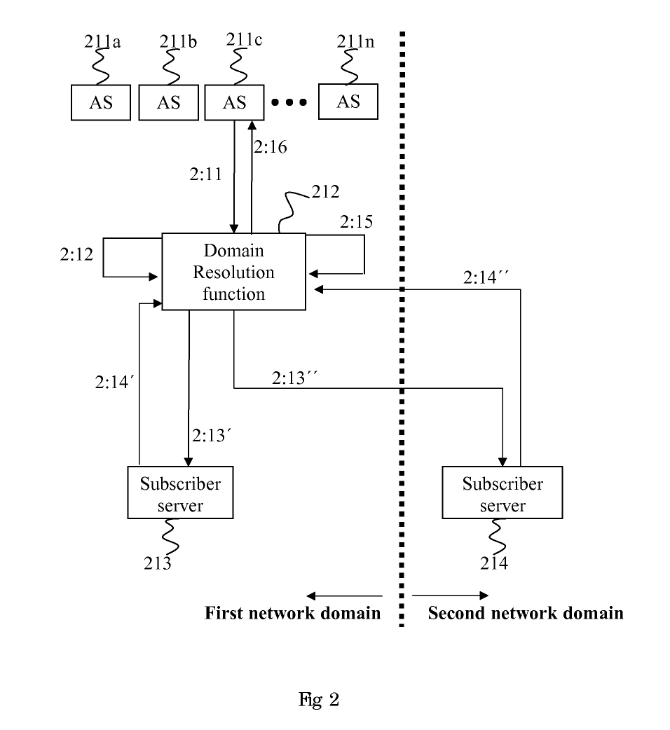

With reference to FIG. 2, block diagram illustrating an optional embodiment of a procedure for dispatching a request into multiple network domains will now be described. In the scenario illustrated in FIG. 2, a request sent from an AS 211c may comprise implicit or explicit sub-request which may have to be dispatched to subscriber servers which may be present in mutually different network domains.

In a first action 2:11, a request from the AS 211c is received by the domain resolution function 212. As mentioned above, in this scenario, the request comprises at least two domain indicators. Thus, the request may have to be dispatched to multiple subscriber servers 213, 214 present in different domains. The domain resolution function 212 may hence divide the received request into plural sub-requests. A respective target network domain is determined to one or more of the divided sub-requests, indicated by action 2:12.

The sub-requests are then dispatched to two or more subscriber servers 213, 214 present in a corresponding target domain, illustrated by action 2:13′ and action 2:13″. If applicable, the subscriber servers may provide a response to the sub-requests. A response, from a subscriber server, to a corresponding sub-request is hereafter referred to as a sub-response.

In this example, One or more sub-responses are provided from the subscriber servers and being received by the domain resolution function 212, which are indicated in action 2:14′ and in action 2:14″. According to one example embodiment, the domain resolution function 212 may, as indicated in action 2:15, store the received sub-responses until a predetermined condition is satisfied. Then, the sub-responses may be aggregated into a complete response which is provided to the AS 211c in action 2:16. According to one possible embodiment, the sub-responses are stored until all sub-responses corresponding to the sub-requests are received. According to another possible embodiment, one or more sub-responses may be stored for a preset or predetermined time period. When the time period lapses or when all sub-responses have been received, a complete response is aggregated and thereafter provided to the AS 211c, as indicated in action 2:16. The embodiment disclosed with reference to FIG. 2 enable the domain resolution function 212 to dispatch sub-requests into two or more target domains based on a single request from the AS 211c. Moreover, the sub-responses may be aggregated into a single response provided to the AS, where the single response is based on one or more of the sub-requests.

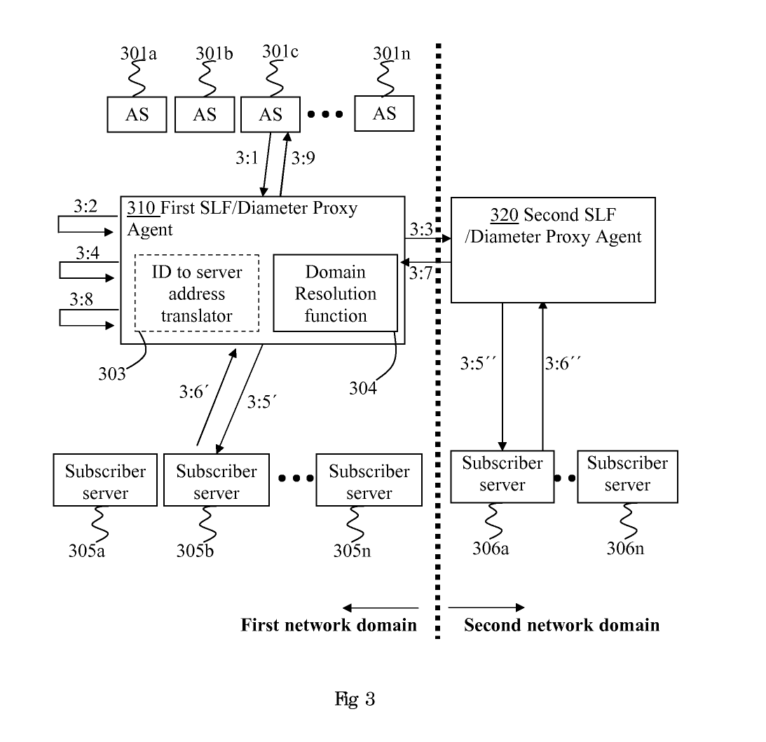

With reference to FIG. 3, a block diagram illustrating an optional embodiment of a procedure for dispatching a request into two or more network domains will now be described. In the embodiment described in FIG. 3, the domain resolution function 303 may be co-located, or be residing in, a first Subscriber Location Function (SLF) or a Diameter Proxy Agent 310. However, similarly to the procedures described above, the first SLF/Diameter Proxy Agent 310, and thus also the domain resolution function 303, is still present in the first network domain together with the AS(s) 301a-n. In the presence of two or more subscriber servers in each network domain, each network domain may keep a SLF/Diameter Proxy Agent 310,320 which dispatches requests to the intended subscriber server.

An SLF/Diameter Proxy Agent may generally translate an identity of a user, e.g. a subscriber ID, into a subscriber server address. In one embodiment, an SLF, which may act as a Diameter Redirect Agent, provides the address to the receiving subscriber server to the AS. In another embodiment, an SLF may work as a Diameter Proxy Agent which dispatches the request to the corresponding subscriber server. According to one particular embodiment, the SLF/Diameter Proxy Agent 310 which the domain resolution function 303 is co-located with, may be an SLF/Diameter Proxy Agent towards HSSs in IMS.

With reference to FIG. 3, a flow of actions in a procedure for dispatching the sub-requests will now be described. In a first action 3:1, an AS 301c provides a request which is received by a first SLF/Diameter Proxy Agent 310 and passed on to the domain resolution function 304. The request comprises at least two domain indicators in this scenario. Thus, in action 3:2, the domain resolution function 304 divides the request into plural sub-requests and determines a target network domain to one or more of the sub-requests. If a second SLF/Diameter Proxy Agent 320 is present in the second network domain, then the sub-request which is destined to the second network domain may optionally be provided, in action 3:3, to the second SLF/Diameter Proxy Agent 320 for further dispatching.

For the sub-request intended for the first domain, the first SLF/Diameter Proxy Agent 310 may translate the identity of the subscriber to a subscriber server address, indicated by action 3:4, which is performed by an ID to address translator 303 in the first SLF/Diameter Proxy Agent 310. A corresponding translation may be performed, when the sub-request is received, by the second SLF/Diameter Proxy Agent 320 which is present in the second network domain.

In actions 3:5′, 3:5″, the first SLF/Diameter Proxy Agent 310 and the second SLF/Diameter Proxy Agent 320 dispatches the sub-requests to the identified subscriber server 305b, 306a, respectively. In actions 3:6′, 3:6″ the subscriber server 305a-n, 306a-n may respond by providing sub-responses to the sub-requests of action 3:5′, 3:5″. The second SLF/Diameter Proxy Agent 320 may relay the received sub-response from the second network domain to the first SLF/Diameter Proxy Agent 310 in action 3:7. According to one possible scenario, the sub-responses from the first and the second network domain are received at different points separated by a time period. Then, the SLF/Diameter Proxy Agent 310 may be adapted to store the sub-responses until a complete response, comprising sub-responses to all sub-requests, can be aggregated and formed, which is indicated in action 3:8. According to another example embodiment, the sub-responses are stored for a predefined time period before they are aggregated and formed into a complete response. Then, in a concluding action 3:9, the aggregated response may be provided to the requesting AS 301c.

Although the block charts, scenarios and procedures in FIGS. 1-3 are described with respect to a first and a second network domain, the second network domain could represent any number of network domains. Moreover, the relationship between the entities and units in FIGS. 1-3 should primarily be interpreted as functional relationships rather than spatial relationships.

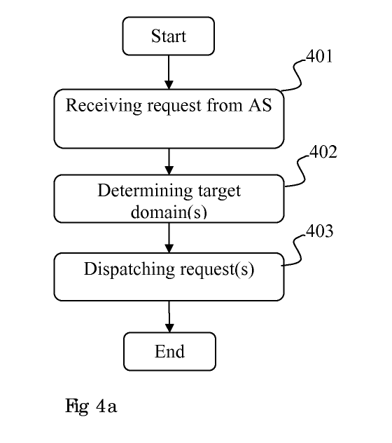

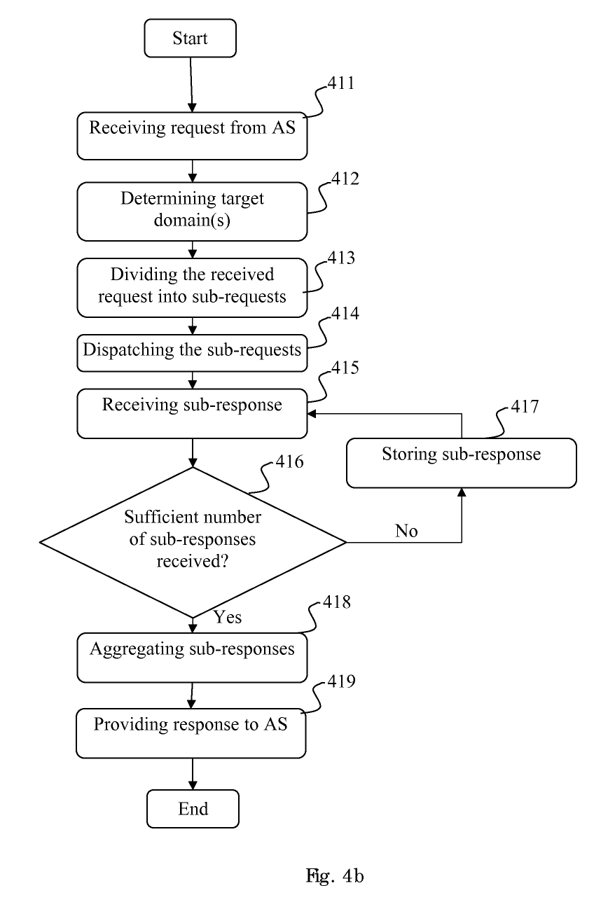

With reference to FIG. 4a, a procedure for performing domain resolution prior to dispatching a request, will now be described. The procedure described with reference to FIG. 4a may be performed by the domain resolution function described above with reference to FIGS. 1-3.

A network element, present in a first network domain, receives a request from an AS in action 401. The AS is also present in the first network domain. In action 402, the network element determines at least one target network domain based on at least one domain indicator being comprised in the request received in action 401. The target network domain is one of the first network domain and a second network domain. The domain indicator is associated with at least a part of the request. However, the domain indicator may also be associated with the complete request which is received in action 401. Then, the part of the request, or the complete request, being associated with the domain indicator is dispatched, as indicated by action 403, to a subscriber server being present in the determined target network domain. By performing the procedure of FIG. 4a, the domain resolution function may dispatch a request, received from an AS, regardless of the target network domain of the receiving subscriber server. Hence, the AS may only need to support one interface towards the network element performing the domain resolution function instead of independent interfaces to the network elements present in the first and network elements present in the second network domain. Moreover, the procedure described above may enable a hidden subscriber server topology.

With reference to FIG. 4b, a procedure for performing domain resolution prior to dispatching a request, will now be described. In this optional example embodiment, the procedure comprises one or more optional actions for handling a request from an AS which comprises sub-request. In particular, a procedure handling sub-requests which are destined to different target domains, i.e. a first sub-request to a first network domain and a second sub-request to a second network domain.

In a first action 411, the network element, present in a first network domain, receives a request from an AS. Then, in action 412, one or more target domains are determined based on one or more domain indicators comprised in the request received in action 411. If the request comprises two or more sub-requests having domain indicators indicating different target network domains, then the network element may divide the request into sub-requests in action 413 which are then dispatched to the respective target network domain in action 414.

In action 415, a sub-response to a dispatched sub-request is received. If the network element requires one or more further sub-responses in order to aggregate a complete response to the AS(s), as determined in action 416, then the sub-response of action 415 is stored temporarily in the network element, as indicated in action 417. Then, one or more further sub-responses may be received by repeating actions 415-416, until all required sub-responses have been received. Hence, if a sufficient number of responses to the sub-requests are received, the stored and received sub-responses are aggregated and formed to a single response, in action 418, being provided to the AS in action 419.

The procedure described with reference to FIG. 4b may enable an AS to provide a request which requires responses from two or more subscriber servers being present in mutually different network domains. Moreover, the procedure described above may enable the network element to collect and store sub-requests before the sub-requests are aggregated into a complete request. This procedure may decrease the number of responses provided from the network element to the AS(s).

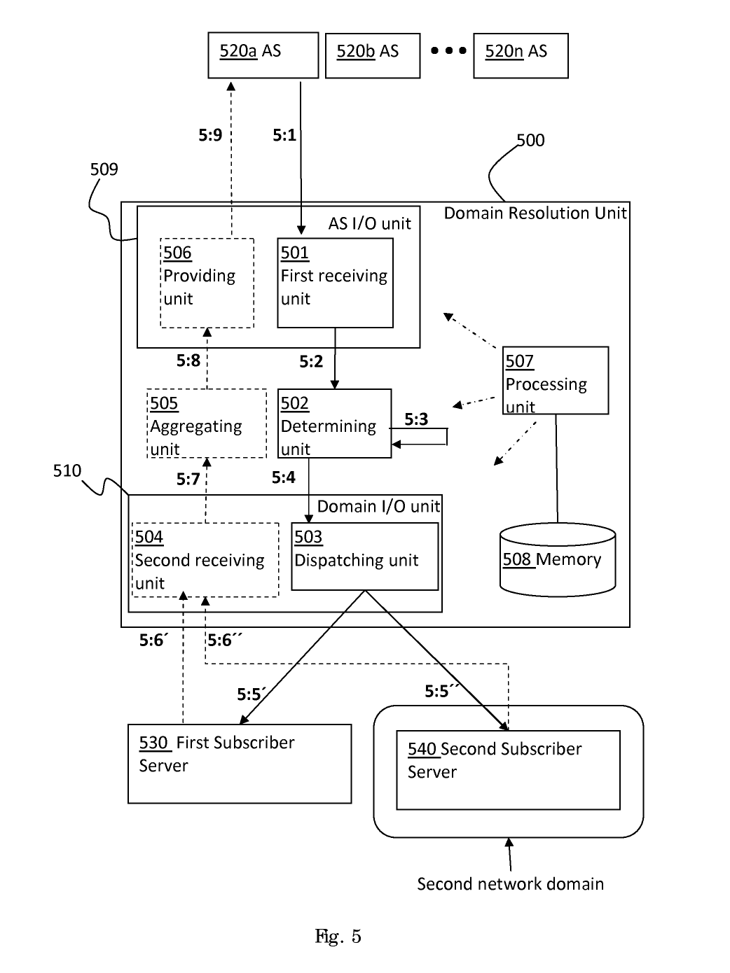

With reference to FIG. 5, an arrangement in a domain resolution unit 500 will now be described. The arrangement in the domain resolution unit 500 may be adapted to perform the flows of the actions described above with reference to FIGS. 1-4b. The relationship between the units in the embodiment described below should primarily be interpreted as functional relationships rather than spatial relationships.

The domain resolution function 500 comprises a first receiving unit 501 which is adapted to receive a request from an AS 520a-n. The first receiving unit 501 may be arranged in an AS Input/output (I/O) unit 509 being arranged in the domain resolution function and which may be adapted to communicate with the AS 520a-n. The AS I/O unit 509 may also comprise a providing unit 506 which may be adapted to provide responses to one or more AS 520a-n. The responses are normally the result from one or more requests provided form the AS 520a-n. However, it should be noted that the requests normally needs to be processed by several other units and subscriber servers before the providing unit 506 can provide a response to the ASs 520a-n.

In order to describe the function of the units 501-503 in the arrangement 500, a flow of events will now be described. The receiving unit 501 as adapted to receive a request from the AS 520a, which is indicated by action 5:1. The receiving unit 501 is adapted to provide the request to a determining unit 502, comprised in the domain resolution unit 500, indicated by action 5:2. The determining unit 502 is adapted to determine, based on one or more domain indicators in the request, at least one target network domain, which is indicated in action 5:3.

The determining unit 502 is then adapted to provide the request and dispatching instructions to a dispatching unit 503 in action 5:4. The dispatching unit 503 is adapted to dispatch the request to a subscriber server present in a target domain. The dispatching unit 503 may be comprised in a domain I/O unit 510 which also may comprise a second receiving unit 504 which is adapted to receive responses from a first subscriber server 530 and/or a second subscriber server 540. As shown in action 5:5′, 5:5″, the dispatching unit 503 is thus adapted to dispatch the request to a subscriber server 530, 540 in a target network domain.

The domain resolution unit 500 further comprises a processing unit 507 and a memory 508. The processing unit 507 may be adapted to process and distribute instructions and requests between the units 501-506 comprised in the domain resolution unit 500. The memory 508 may also be adapted to store responses, requests and states associated with one or more of the ASs 520a-n.

According to one embodiment, the domain resolution unit 500 may be adapted to receive and dispatch requests from an AS, where the request comprises sub-requests destined to different target network domains. According to one possible scenario where a request comprises two or more domain indicators forming two or more sub-requests which are destined to different target domains, the determining unit 502 may be adapted to determine a target domain for respective sub-request in action 5:3. The dispatching unit 503 may then be adapted to dispatch the sub-request to its respective subscriber server in action 5:5′, 5:5″.

Although the first subscriber server 530 is present in the first network domain which is the same as the domain resolution function 500 in FIG. 5, other embodiments are possible. The first subscriber server may for instance be present in another network domain which is different from the second network domain and also different from the network domain of the AS 520a-n and the domain resolution function 500.

The second receiving unit 504, as mentioned above, may be adapted to receive responses from one or more subscriber servers 530, 540, which is indicated by action 5:6′, 5:6″. The second receiving unit 504 may then provide the received responses, as indicated in action 5:7, to an aggregating unit 505 comprised in the domain resolution function 500. The aggregating unit 505 may be adapted to aggregate two or more sub-responses into a single response which may be provided to an AS 520a-n. The aggregating unit 505 may also, based on the state of the request, keep track of whether or not a sufficient number of sub-responses are received, in order to form an aggregated single response to an AS 520a-n.

The aggregating unit 505 may be adapted to provide a response to the providing unit 506 in action 5:8. In action 5:9, the providing unit 506 provides the response to the requesting AS 520a-n.

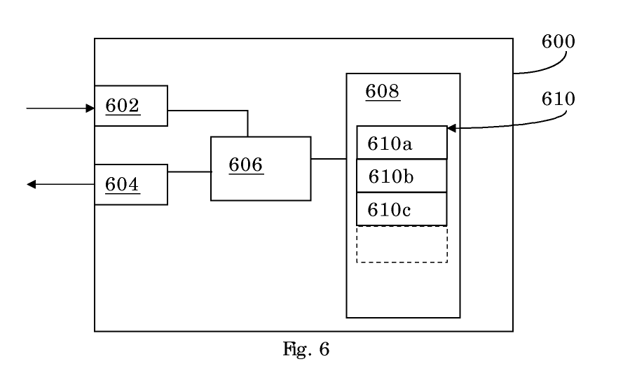

FIG. 6 schematically shows an embodiment of an arrangement 600 in a domain resolution unit, which also can be an alternative way of disclosing an embodiment of the arrangement for dispatching requests from an AS to one or more network domains, as illustrated in FIG. 5 and described above. The arrangement 600 comprises a processing unit 606, e.g. with a DSP (Digital Signal Processor), a receiving module 610a, a determining module 610b and a providing module 610c. The processing unit 606 can be a single unit or a plurality of units to perform different actions of procedures described herein. The arrangement 600 may also comprise an input unit 602 for receiving signals and information from other entities such as ASs or subscriber servers, and an output unit 604 for providing signals, requests and responses or other type of information to entities such as ASs or subscriber servers. The input unit 602 and the output unit 604 may be arranged as an integrated entity.

Furthermore, the arrangement 600 comprises at least one computer program product 608 in the form of a non-volatile memory, e.g. an EEPROM (Electrically Erasable Programmable Read-Only Memory), a flash memory and a disk drive. The computer program product 608 comprises a computer program 610, which comprises code means, which when run in the processing unit 606 in the arrangement 600 causes the arrangement to perform the actions of the procedures described earlier in conjunction with FIG. 1 to FIG. 4b.

The computer program 610 may be configured as a computer program code structured in computer program modules. Hence in the example embodiments described, the code means in the computer program 610 of the arrangement 600 comprises a receiving module 610a for receiving a request from an AS. The computer program further comprises a determining module 610b for determining, based on a domain indicator, to which target domain the request shall be dispatched. The computer program 610 further comprises a dispatching module 610c for dispatching the request to a subscriber server in the target network domain. The request may be provided to the target domain using the output unit 704.

The modules 610a-c could essentially perform the actions of the flow illustrated in FIG. 4a, to emulate the arrangement in a domain resolution function illustrated in FIG. 5. In other words, when the different modules 610a-c are run on the processing unit 606, they correspond to the units 501-503 of FIG. 5.

Similarly, a corresponding alternative to perform the actions of the flow illustrated in FIG. 4b is possible by adding additional computer program modules.

Although the code means in the embodiment disclosed above in conjunction with FIG. 6 are implemented as computer program modules which when run on the processing unit causes the arrangement and/or domain resolution function to perform the actions described above in the conjunction with FIGS. 1-5 mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product comprises a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the data receiving unit.

A domain resolution function, unit or procedure, as above described, may contribute to a more dynamic communication between ASs and subscriber servers. In some systems, hiding the subscriber server topology from the AS may be desirable. By having one domain resolution function co-located with a SLF/Diameter Proxy Agent, seamless scaling at the AS-side and the subscriber server side is possible.

By using a domain resolution function, the AS processing capacity is off loaded on behalf of the dedicated network element which may be specially developed for providing resolution functionality.

While the invention has been described with reference to specific exemplary embodiments, the description is generally only intended to illustrate the inventive concept and should not be taken as limiting the scope of the invention. The invention is defined by the appended claims.

### ABBREVIATIONS

3GPP—3rd Generation Partnership Project

AS—Application Server

CS—Circuit Switched

EPC—Evolved Packet Core

HSS—Home Subscriber Server

IMS—IP Multimedia Subsystem

LTE—Long Term Evolution

NE—Network Equipment

PS—Packet Switched

FMC—Fixed Mobile Convergence

VoLTE—Voice over Long Term Evolution

HLR—Home Location Registry

1. A method, performed by a network node for dispatching a request, the method comprising:
receiving a request from an Application Server (AS), wherein said AS and said network node are present in a first network domain;
performing domain resolution by determining at least one target network domain based on at least one domain indicator in said request, wherein said domain indicator being associated with at least a part of said request, wherein said target network domain is one of: said first network domain and a second network domain, the domain indicator indicating to which of the first network domain and the second network domain the request is intended; and
dispatching said at least part of said request, to at least one subscriber server present in said determined target network domain(s).

2. The method according to claim 1, wherein the at least one indicator comprises a first domain indicator indicating said first network domain, and a second domain indicator indicating said second network domain,
wherein said request is divided into a first sub-request associated with said first domain indicator, wherein said first sub-request is dispatched to a subscriber server present in a first target network domain, and a second sub-request associated with said second domain indicator, wherein said second sub-request is dispatched to a subscriber server present in a second target network domain.

3. The method according to claim 2, wherein two or more responses to said dispatched sub-requests are received and aggregated to form a response to said AS, from two or more domains.

4. The method according to claim 1, wherein said domain indicator is one of: a data reference and a domain request.

5. The method according to claim 1, wherein said first and second network domain is one of: IP Multimedia System (IMS), General packet radio service (GPRS) network, Evolved Packet Core (EPC) network, and Circuit Switched (CS) network.

6. The method according to claim 1, wherein said network node is a Subscriber Location Function (SLF) or a Diameter Proxy Agent.

7. The method according to claim 1, wherein the at least one domain indicator is a data reference type comprised in a SH request message or additional information in the SH request message relating to the at least one target network domain.

8. A domain resolution unit adapted to dispatch a request, the domain resolution unit comprising:
a first receiving unit, adapted to receive a request from an Application Server (AS), wherein said AS and said domain resolution unit are present in a first network domain;
a determining unit, adapted to perform domain resolution by determining at least one target network domain based on at least one domain indicator in said request, wherein said domain indicator being associated with at least a part of said request, wherein said target network domain is one of: a said first network domain and a second network domain, the domain indicator indicating to which network domain the request is intended; and
a dispatching unit, adapted to dispatch, said at least part of said request, to at least one subscriber server present in said determined target network domain(s).

9. The domain resolution unit according to claim 8, wherein said first receiving unit is adapted to receive said request comprising a first domain indicator indicating said first network domain, and a second domain indicator indicating said second network domain,
wherein said determining unit is further adapted to divide said request into a first sub-request associated with said first domain indicator, wherein said first sub-request is dispatched, by said dispatching unit, to a subscriber server present in a first target network domain, and a second sub-request associated with said second domain indicator, wherein said second sub-request is dispatched, by said dispatching unit, to a subscriber server present in a second target network domain.

10. The domain resolution unit according to claim 9, wherein said domain resolution unit further comprising:
a second receiving unit, adapted to receive at least one or more sub-responses from said first target network domain and/or said second target network domain;
an aggregation unit, adapted to aggregate said received sub-responses into an AS response; and
a providing unit, adapted to provide said AS response to said AS.

11. The domain resolution unit according to claim 8, wherein said determining unit is further adapted to determine based on a domain indicator being one of: a data reference and a domain request.

12. The domain resolution unit according to claim 8, wherein said dispatching unit is further adapted to dispatch requests into a first and second network domain being one of: IP Multimedia System (IMS), General packet radio service (GPRS) network, Evolved Packet Core (EPC) network, and Circuit Switched (CS) network.

13. The domain resolution unit according to claim 8, wherein said domain resolution unit is co-located with a Subscriber Location Function (SLF) or a Diameter Proxy Agent.

14. The domain resolution unit according to claim 8, wherein the at least one domain indicator is a data reference type comprised in a SH request message or additional information in the SH request message relating to the at least one target network domain.
